(19) United States
(12) Patent Application Publication
(10) Pub. No.: US 2026/0364932 A1
(43) Pub. Date: Nov. 19, 2026

(54) APPARATUS AND METHOD FOR PREPARING PRODUCT CONTAINING TRANSFER GLAZE COATING

(71) Applicant: BANFERT NEW MATERIALS CO., LTD., Changsha (CN)

(72) Inventors: Xinxiong LI, Changsha (CN); Hui LI, Changsha (CN); Dongming ZHANG, Changsha (CN)

(21) Appl. No.: 19/342,030

(22) Filed: Sep. 26, 2025

Related U.S. Application Data
(63) Continuation-in-part of application No. PCT/CN2025/097777, filed on May 28, 2025.

(30) Foreign Application Priority Data
May 14, 2025 (CN) 202510619536.X

(51) Int. Cl. B32B 37/00; B05C 1/00; B05C 1/02; B05C 13/00; B32B 17/10; B32B 38/00; C08J 7/04; C09D 4/00; C09D 7/40; C09D 7/61; C09D 133/04

(52) U.S. Cl. CPC B32B 37/025; B05C 1/003; B05C 1/025; B05C 13/00; B32B 17/10; C08J 7/042; C09D 4/00; C09D 7/61; C09D 7/69; C09D 133/04; B32B 2038/0076; B32B 2250/02; B32B 2264/10; B32B 2264/303; B32B 2307/7376; C08J 2367/02; C08J 2433/04

(57) ABSTRACT

Provided are an apparatus and a method for preparing a product containing a transfer glaze coating. The apparatus includes: an unwinding device for a transfer film and a winding device for the transfer film; a transfer glaze coating application device, a first UV curing device, a first pressure roller, a second UV curing device, and a second pressure roller which are sequentially arranged in a running direction of the transfer film; and a substrate transport device.

### CROSS REFERENCE TO RELATED APPLICATION

The present disclosure is a continuation-in-part of International Patent Application No. PCT/CN2025/097777, filed on May 28, 2025, which claims priority to Chinese Patent Application No. CN202510619536.X, filed with the China National Intellectual Property Administration on May 14, 2025 and entitled “APPARATUS AND METHOD FOR PREPARING PRODUCT CONTAINING TRANSFER GLAZE COATING”. The disclosure of the two applications is incorporated by reference in its entirety.

### TECHNICAL FIELD

The present disclosure belongs to the technical field of decorative materials, and in particular relates to an apparatus and a method for preparing a product containing a transfer glaze coating.

### BACKGROUND

Floor decorative panels, such as floor tiles or floors, are generally composed of substrates and coatings on surfaces of the substrates, and in order to achieve excellent wear and scratch resistance, it is necessary to add high-hardness inorganic wear-resistant materials to the coatings. Once directly applied to the surfaces of the substrates, the inorganic wear-resistant materials may form diffuse reflection on the coated surfaces, resulting in a failure to realize a mirror-like high-gloss effect. The related art discloses that a polymer film is coated to obtain a coating having a high-gloss effect and excellent wear and scratch resistance, and then the coated polymeric film is laminated onto a substrate. However, in mass production, it is found that the method arouses a long time of coating on the polymer film, a long travel path of the polymer film, and serious static accumulation, such that the coated surface is prone to adsorb dust, particles and the like, which results in surface defects and hence a low product qualification rate.

### SUMMARY

In view of this, an object of the present disclosure is to provide an apparatus and a method for preparing a product containing a transfer glaze coating. According to the present disclosure, the apparatus for preparing the product containing the transfer glaze coating can achieve integration of glazed coating application and film-pressing processes on a transfer film, and can prepare the product containing the transfer glaze coating on a continuous production line using different substrates. The apparatus is simple, exhibits a short path of production line path, can ensure the product yield, and thus is suitable for industrial mass production.

The present disclosure provides an apparatus for preparing a product containing a transfer glaze coating, including:
an unwinding device 1 for a transfer film and a winding device 2 for the transfer film;
a transfer glaze coating application device 5, a first UV curing device 6, a first pressure roller 8, a second UV curing device 9, and a second pressure roller 10 which are sequentially arranged in a running direction of the transfer film; and
a substrate transport device 15.

In some embodiments, each of the first UV curing device 6 and the second UV curing device 9 includes a lamp source, where the lamp source includes at least one selected from the group consisting of a gallium lamp, a mercury lamp, a UV-LED lamp, a halogen lamp, and an electrodeless lamp.

In some embodiments, the apparatus for preparing the product containing the transfer glaze coating further includes: a substrate application device 11 configured to prepare a substrate to be transferred, where the substrate application device 11 is one selected from the group consisting of a reversible roller coater and a laser roller coater.

In some embodiments, the apparatus for preparing the product containing the transfer glaze coating further includes: a third curing device 13 configured to cure a product from which the transfer film is removed, where the third curing device 13 includes a lamp source, where the lamp source includes at least one selected from the group consisting of a gallium lamp, a mercury lamp, a UV-LED lamp, a halogen lamp, an electrodeless lamp, and an EB curing machine.

In some embodiments, the transfer glaze coating application device 5 includes a uniform distribution roller 51, an application roller 52, and a bottom roller 53.

The present disclosure also provides a method for preparing the product containing the transfer glaze coating by using the apparatus as described in the above technical solutions, including the following steps:
connecting the transfer film 4 from the unwinding device 1 to the winding device 2 through the transfer glaze coating application device 5, the first UV curing device 6, the first pressure roller 8, the second UV curing device 9, and the second pressure roller 10 in sequence;
applying a UV glazed paint onto a surface of the transfer film 4 by using the transfer glaze coating application device 5, and subjecting a resulting product to a first curing by using the first UV curing device 6 to obtain a transfer film coated with the transfer glaze coating; and
laminating, through the first pressure roller 8 and the second pressure roller 10, the transfer film coated with the transfer glaze coating on a surface of a substrate to be transferred, subjecting a resulting system to a second curing by using the second UV curing device 9 during the laminating, collecting the transfer film 4 by using the winding device 2, and transferring the transfer glaze coating 7 to the surface of the substrate to be transferred to obtain the product containing the transfer glaze coating.

In some embodiments, the transfer film includes one selected from the group consisting of a polyester film, a polypropylene film, and a polyethylene film; and the transfer film has a thickness of 20 μm to 500 μm.

In some embodiments, raw materials for preparing the UV glazed paint include the following components in parts by mass: 5 parts to 50 parts of wear-resistant particles, 10 parts to 80 parts of a polyfunctional acrylate resin, 0 to 50 parts of a photocurable resin, 1 part to 5 parts of a photoinitiator, 0 to 50 parts of an active diluent, and 0.1 parts to 5 parts of an additive.

In some embodiments, the substrate to be transferred includes a substrate 14 and an intermediate coating 12 on a surface of the substrate, where the intermediate coating is an uncured UV coating.

In some embodiments, the method further includes: after transferring the transfer glaze coating 7 to the surface of the substrate to be transferred, subjecting a resulting product from which the transfer film is removed to a third curing by using a third curing device 13.

Compared with conventional technology, some embodiments of the present disclosure have the following beneficial effects:

The present disclosure provides an apparatus for preparing a product containing a transfer glaze coating, including: an unwinding device 1 for a transfer film and a winding device 2 for the transfer film; a transfer glaze coating application device 5, a first UV curing device 6, a first pressure roller 8, a second UV curing device 9, and a second pressure roller 10 which are sequentially arranged in a running direction of the transfer film; and a substrate transport device 15. The apparatus for preparing the product containing the transfer glaze coating can achieve integration of glazed coating application and film-pressing processes on the transfer film, and can prepare the product containing the transfer glaze coating on a continuous production line using different substrates. The apparatus is simple, exhibits a short path of production line, avoids the problems of static accumulation and dust adsorption, can ensure the product yield, is high in environmental tolerance, and thus is suitable for industrial mass production.

The present disclosure also provides a method for producing the product containing the transfer glaze coating by using the apparatus as described in the above technical solutions. The method is convenient to operate, obtains the transfer glaze coating on a surface of a substrate, and can prepare a decorative panel with excellent wear and scratch resistance, a mirror-like effect or other glossy and textured effects, of which the performance is even comparable to that of ceramic tiles, thereby breaking the bottleneck of the existing application technology.

### BRIEF DESCRIPTION OF THE DRAWINGS

To illustrate the technical solutions in the embodiments of the present disclosure or prior art more clearly, the accompanying drawings required for the embodiments are briefly described below. Apparently, the accompanying drawings in the following description show merely some embodiments of the present disclosure, and those of ordinary skill in the art may still derive other accompanying drawings from these accompanying drawings without inventive efforts.

FIG. 1s a schematic structural diagram of an apparatus for preparing a product containing a transfer glaze coating according to an embodiment of the present disclosure.

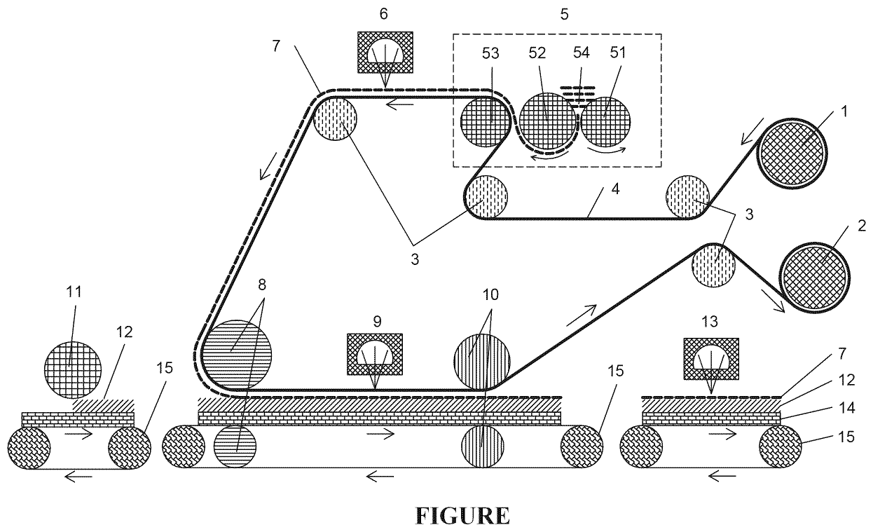

In the FIGURE: 1 represents unwinding device; 2 represents winding device; 3 represents guide roller; 4 represents transfer film; 5 represents transfer glaze coating application device; 51 represents uniform distribution roller; 52 represents application roller; 53 represents bottom roller; 54 represents glazed paint; 6 represents first UV curing device; 7 represents transfer glaze coating; 8 represents first pressure roller; 9 represents second UV curing device; 10 represents second pressure roller; 11 represents substrate application device; 12 represents intermediate coating; 13 represents third curing device; 14 represents substrate; 15 represents substrate transport device.

### DETAILED DESCRIPTION OF THE EMBODIMENTS

The present disclosure provides an apparatus for preparing a product containing a transfer glaze coating, including:
an unwinding device 1 for a transfer film and a winding device 2 for the transfer film;
a transfer glaze coating application device 5, a first UV curing device 6, a first pressure roller 8, a second UV curing device 9, and a second pressure roller 10 which are sequentially arranged in a running direction of the transfer film; and
a substrate transport device 15.

In the present disclosure, unless otherwise specified, materials and equipment used are commercially available in the art.

A schematic structural diagram of the apparatus for preparing the product containing the transfer glaze coating in an embodiment of the present disclosure is as shown in FIGURE. The apparatus according to the present disclosure can prepare a decorative panel with excellent wear and scratch resistance, a mirror-like effect or other glossy and textured effects on a continuous production line.

In some embodiments of the present disclosure, the unwinding device 1 is a device that can spread the transfer film 4 that is in roll form at a uniform speed as required by a production line speed, and the winding device 2 is a device for winding and collecting the transfer film at a uniform speed as required by the production line speed.

In some embodiments of the present disclosure, a guide roller 3 is further arranged between the unwinding device 1 and the transfer glaze coating application device 5, where the guide roller is configured to control a direction of the transfer film.

In some embodiments of the present disclosure, the transfer glaze coating application device 5 is a device that can uniformly apply a UV glazed paint to the transfer film, and the transfer glaze coating application device 5 includes a uniform distribution roller 51, an application roller 52, and a bottom roller 53. The application roller uniformly applies the glazed paint to the transfer film, and a coating thickness may be controlled by controlling a speed of rotation of the uniform distribution roller. In some embodiments of the present disclosure, the transfer glaze coating application device further includes other control and connection components, for example, a motor.

In some embodiments of the present disclosure, the first UV curing device 6 includes a lamp source, where the lamp source includes at least one selected from the group consisting of a gallium lamp, a mercury lamp, a UV-LED lamp, a halogen lamp, and an electrodeless lamp, and is more preferably the gallium lamp, the mercury lamp, or the UV-LED lamp.

In some embodiments of the present disclosure, a guide roller 3 is further arranged between the first UV curing device 6 and the first pressure roller 8.

In some embodiments of the present disclosure, the first pressure roller 8 and the second pressure roller 10 are configured to laminate the transfer film coated with the transfer glaze coating onto a substrate to be transferred. In some embodiments of the present disclosure, the substrate to be transferred includes a substrate 14 and an intermediate coating 12 on a surface of the substrate, where the intermediate coating is an uncured UV coating. The first pressure roller and the second pressure roller cause the transfer film coated with the transfer glaze coating to be laminated onto the substrate coated with the UV intermediate coating, the transfer glaze coating is in contact with the UV intermediate coating, and whole coating is cured under the action of the second UV curing device 9, and the transfer glaze coating is fixed to the surface of the substrate to be transferred to obtain the product containing the transfer glaze coating.

In some embodiments of the present disclosure, each of the first pressure roller 8 and the second pressure roller 10 includes an upper roller and a lower roller, where the upper roller is placed above the transfer film coated with the transfer glaze coating, and the substrate to be transferred is placed between the transfer film coated with the transfer glaze coating and the substrate transport device.

In some embodiments of the present disclosure, the second UV curing device 9 includes a lamp source, where the lamp source includes at least one selected from the group consisting of a gallium lamp, a mercury lamp, a UV-LED lamp, a halogen lamp, and an electrodeless lamp, and is more preferably the gallium lamp or the UV-LED lamp.

In some embodiments of the present disclosure the apparatus for preparing the product containing the transfer glaze coating further includes: a substrate application device 11 and a third curing device 13.

In some embodiments of the present disclosure, the substrate application device 11 is configured to apply a UV intermediate paint onto the surface of the substrate to form the intermediate coating 12. In some embodiments of the present disclosure, the substrate application device is a reversible roller coater or a laser roller coater, so that a resulting coated UV intermediate coating is favorable in surface smoothness.

In some embodiments of the present disclosure, the third curing device 13 includes a lamp source, where the lamp source includes at least one selected from the group consisting of a gallium lamp, a mercury lamp, a UV-LED lamp, a halogen lamp, an electrodeless lamp, and an EB curing machine, and is more preferably the gallium lamp+the mercury lamp, the UV-LED lamp+the mercury lamp or the EB curing machine. In some embodiments of the present disclosure, the third curing device 13 is configured to cure a product from which the transfer film is removed.

In some embodiments of the present disclosure, the substrate transport device 15 is configured to transport the substrate to be coated with the intermediate coating, a substrate of which a glaze coating is to be transferred (the substrate to be transferred) or the product from which the transfer film is removed.

In some embodiments of the present disclosure, the apparatus for preparing the product containing the transfer glaze coating further includes: a device configured to linkage control of the first UV curing device and the second UV curing device, i.e., lamp sources of the first UV curing device and the second UV curing device are immediately shielded or stopped from emitting ultraviolet light when the transfer film stops running.

In some embodiments of the present disclosure, the apparatus for preparing the product containing the transfer glaze coating further includes, but is not limited to, motor, traction, and storage assisting apparatuses that keep the apparatus running stably, at a uniform line speed and in the same direction. In the present disclosure, there are no special requirements for the assisting apparatuses.

The present disclosure also provides a method for preparing the product containing the transfer glaze coating by using the apparatus as described in the above technical solutions, including the following steps:
connecting the transfer film 4 from the unwinding device 1 to the winding device 2 through the transfer glaze coating application device 5, the first UV curing device 6, the first pressure roller 8, the second UV curing device 9, and the second pressure roller 10 in sequence;
applying a UV glazed paint onto a surface of the transfer film 4 by using the transfer glaze coating application device 5, and subjecting a resulting product to a first curing by using the first UV curing device 6 to obtain a transfer film coated with the transfer glaze coating 7; and
laminating, through the first pressure roller 8 and the second pressure roller 10, the transfer film coated with the transfer glaze coating on a surface of a substrate to be transferred, subjecting a resulting system to a second curing by using the second UV curing device 9 during the laminating, collecting the transfer film by using the winding device 2, and transferring the transfer glaze coating 7 to the surface of the substrate to be transferred to obtain the product containing the transfer glaze coating.

In the present disclosure, the transfer film 4 is connected from the unwinding device 1 to the winding device 2 through the transfer glaze coating application device 5, the first UV curing device 6, the first pressure roller 8, the second UV curing device 9, and the second pressure roller 10 in sequence.

In some embodiments of the present disclosure, the transfer film is a polymer film, where the polymer film includes one selected from the group consisting of a polyester (PET) film, a polypropylene (PP) film, and a polyethylene (PE) film. In some embodiments of the present disclosure, the transfer film has a thickness of 20 μm to 500 μm, in particular 30 μm, 50 μm, 100 μm or 200 μm. In some embodiments of the present disclosure, the surface of the transfer film is applied with a release agent, which facilitates subsequent stripping of the transfer film. With the flat mirror-like characteristic of the transfer film, the transferred glaze coating can achieve the mirror-like effect of ceramic tiles; and transfer films with different glossiness and textures may also be chosen, so that the transferred glaze coating can achieve different glossiness and textured effects.

In the present disclosure, the UV glazed paint is applied onto the surface of the transfer film 4 by using the transfer glaze coating application device 5, and the resulting product is subjected to the first curing by using the first UV curing device 6 to obtain the transfer film coated with the transfer glaze coating.

In some embodiments of the present disclosure, raw materials for preparing the UV glazed paint include the following components in parts by mass: 5 parts to 50 parts of wear-resistant particles, 10 parts to 80 parts of a polyfunctional acrylate resin, 0 to 50 parts of a photocurable resin, 1 part to 5 parts of a photoinitiator, 0 to 50 parts of an active diluent, and 0.1 parts to 5 parts of an additive. In some embodiments of the present disclosure, the wear-resistant particles have a Mohs hardness of >9; the wear-resistant particles are at least one selected from the group consisting of alumina, zirconia, silicon carbide, boron carbide, silicon nitride, boron nitride, and diamond micro-powder; and each of the wear-resistant particles have a particle size of 1 μm to 30 μm, more preferably 3 μm to 20 μm. In some embodiments of the present disclosure, the wear-resistant particles within the range of particle size are selected to ensure not only good transparency but also high volume concentration of the wear-resistant particles, and the wear-resistant particles are concentrated on the surface of the coating after the transfer process. In the present disclosure, there are no special requirements for the specific types of the polyfunctional acrylate resin and the photocurable resin, and only those familiar to those skilled in the art can be adopted.

In some embodiments of the present disclosure, the raw materials for preparing the UV glazed paint further include nano-particles, where a mass percentage of the nano-particles in the UV glazed paint is in a range of 0.5% to 10%. In some embodiments of the present disclosure, the nano-particles are at least one selected from the group consisting of alumina, zirconia, silicon carbide, boron carbide, silicon nitride, boron nitride, and diamond nano-particles; and each of the nano-particles have a particle size of 20 nm to 300 nm. In some embodiments of the present disclosure, the nano-particles and the wear-resistant particles are used together, so that the coating exhibits more excellent wear resistance, and the nano-particles may be directly used in the UV glazed paint, and may also be used in the UV glazed paint after being processed by using resin through processes of dispersing, coating, and the like.

In some embodiments of the present disclosure, the transfer glaze coating has a thickness of 3 μm to 20 μm, more preferably 5 μm to 15 μm, and is specifically 8 μm. A side of the transfer glaze coating in contact with the transfer film is isolated from oxygen and thus not affected by oxygen inhibition during UV curing, so that the performance is greatly improved. In addition, high-hardness and high-volume-concentration wear-resistant particles are concentrated on one side of the transfer film and become a surface coating through transfer process to exhibit excellent wear and scratch resistance, and the mirror-like characteristic of the transfer film creates a mirror-like coating. When transfer films with different glossiness and different textures (non-mirror) are selected, the wear and scratch resistance of the coating are far better than that of a conventional application method because the UV glaze coating is not affected by oxygen inhibition during curing due to the transfer process and the high-hardness and high-concentration wear-resistant particles are concentrated on the surface of the coating after transferring.

In some embodiments of the present disclosure, the substrate to be transferred includes a substrate 14 and an intermediate coating 12 on a surface of the substrate, where the intermediate coating is an uncured UV intermediate coating, where the UV intermediate coating is a coating that is high in hardness and favorable in transparency after being cured. In some embodiments of the present disclosure, laminating is performed directly (without curing) after the surface of the substrate is applied with the UV intermediate paint, the transfer glaze coating is in contact with the UV intermediate coating, then whole coating is cured under the action of the second UV curing device 9, the transfer film is collected by the winding device 2, and the transfer film is separated from the glazed coating to obtain the product containing the transfer glaze coating.

In some embodiments of the present disclosure, the substrate includes a first pretreated substrate, a second pretreated substrate, or a third pretreated substrate.

In some embodiments of the present disclosure, the first pretreated substrate includes a first substrate, a first primer layer, a covering white base layer, a pattern layer, and a second primer layer that are sequentially stacked. In some embodiments of the present disclosure, the first substrate includes a plastic substrate, an inorganic board, a wood substrate, or a composite substrate; where the inorganic board includes a calcium silicate board, a phosphorus-magnesium board, a magnesium oxide board, a Yanmu board, or a fiber cement board; and the wood substrate is a solid wood board or a multi-layer solid wood composite board. In some embodiments of the present disclosure, a primer of the first primer layer includes an adhesive primer or a penetrating primer; a surface of the first substrate is applied with the adhesive primer under a condition that the first substrate is the plastic substrate or the wood substrate with good surface strength; and the surface of the first substrate is applied with the penetrating primer to be strengthened under a condition that the first substrate is the inorganic board that exhibits poor surface strength and high porosity. In some embodiments of the present disclosure, a primer of the second primer layer is a wear-resistant primer. In some embodiments of the present disclosure, the first primer layer, the covering white base layer, the pattern layer, and the second primer layer are independently obtained by at least one-time applying, and cured by a gallium lamp or a mercury lamp. In some embodiments of the present disclosure, a filler putty layer is further included between the first primer layer and the covering white base layer. In some embodiments of the present disclosure, an adhesive primer layer is further included between the covering white base layer and the pattern layer to ensure a good bond between the coatings.

In some embodiments of the present disclosure, the second pretreated substrate includes a polymer white film-containing plastic substrate, a pattern layer, an adhesive primer layer, and a primer layer that are sequentially stacked; or, includes a polymer printed film-containing plastic substrate, an adhesive primer layer, and a primer layer that are sequentially stacked; where a polymer white film side of the polymer white film-containing plastic substrate is in contact with the pattern layer. In some embodiments of the present disclosure, the primer layer is a wear-resistant primer layer.

In some embodiments of the present disclosure, the third pretreated plate is a composite plastic substrate, where the composite plastic substrate includes a plastic substrate, a printed film, and a transparent film that are sequentially stacked; where the glazed coating is transferred on one side of the transparent film. In some embodiments of the present disclosure, an adhesive primer and a wear-resistant primer are further arranged on the transparent film to ensure good adhesion and abrasion and scratch resistance of the coating. In some embodiments of the present disclosure, the plastic substrate includes a PVC board, a PET board, a PETG board, or a PP board. In some embodiments of the present disclosure, the pattern layer is obtained by digital printing, where an ink for the digital printing includes a UV ink, a water-based ink, or a solvent-based ink.

In some embodiments of the present disclosure, a lamp source of the first curing has a power of 2 kW to 10 KW and a curing energy of 50 mJ/cm² to 1,000 mJ/cm².

In the present disclosure, after the transfer film coated with the transfer glaze coating is obtained, the transfer film coated with the transfer glaze coating is laminated, using the first pressure roller 8 and the second pressure roller 10, onto the surface of the substrate to be transferred, a resulting system is subjected to a second curing by using the second UV curing device 9 during lamination, the transfer film 4 is collected by using the winding device 2, and the transfer glaze coating 7 is transferred to the surface of the substrate to be transferred to obtain the product containing the transfer glaze coating.

In some embodiments of the present disclosure, a lamp source of the second curing has a power of 2 kW to 10 kW and a curing energy of 100 mJ/cm² to 2,000 mJ/cm².

In some embodiments of the present disclosure, the method further includes: after transferring the transfer glaze coating 7 to the surface of the substrate to be transferred (after separating the transfer film from the transfer glaze coating), subjecting a resulting product from which the transfer film is removed to a third curing by using the third curing device 13 to obtain better hardness, wear resistance and scratch resistance. In some embodiments of the present disclosure, a lamp source of the third curing has a power of 5 kW to 20 kW, and a curing energy of 300 mJ/cm² to 5,000 mJ/cm².

For further illustration of the present disclosure, the apparatus and the method for preparing the product containing the transfer glaze coating according to the present disclosure will be described in detail below with reference to the drawings and examples, which cannot be construed as limiting the scope of the present disclosure.

### Example 1

A schematic structural diagram of an apparatus for preparing a product containing a transfer glaze coating, as shown in FIGURE, consisted of an unwinding device 1, a transfer glaze coating application device 5, a first UV curing device 6, a first pressure roller 8, a second UV curing device 9, a second pressure roller 10, a winding device 2, a plurality of guide rollers 3, a substrate application device 11, a substrate transport device 15, and a third curing device 13.

The transfer glaze coating application device 5 consisted of a uniform distribution roller 51, a coating roller 52, and a bottom roller 53, and a coating thickness was controlled by controlling a speed of rotation of the uniform distribution roller 51.

A lamp source of the first UV curing device 6 was a gallium lamp, a lamp source of the second UV curing device 9 was a gallium lamp, the substrate application device 11 was a reversible roller coater, and a lamp source of the third curing device 13 was a gallium lamp+a mercury lamp. The substrate application device 11 and the third curing device 13 were relatively independent.

The apparatus was also equipped with a device configured to linkage control of the first UV curing device and the second UV curing device, i.e., UV lamp sources of the first UV curing device and the second UV curing device were immediately shielded or stopped from emitting ultraviolet light when the transfer film stopped running.

A method for preparing the product containing the transfer glaze coating by using the apparatus was performed as follows:
1. A calcium silicate board was polished and planarized, then penetrating primer BMZ-5100 was applied thereon at a coating thickness of 40 g/m² and cured with a gallium lamp. 2 coats of filler putty BMZ-3016 were applied at 25 g/m² per coat onto a resulting product, and cured by using a mercury lamp after each coat. 2 coats of covering white base BMZ-824WH were applied at 20 g/m² per coat, and cured by using the gallium lamp after each coat. Then, digital printing was conducted on a resulting product to obtain a pattern layer. Adhesive primer BMZ-855 was applied at a coating thickness of 10 g/m² onto the pattern layer and cured with the mercury lamp. Wear-resistant primer BMZ-323C was applied at a coating thickness of 80 g/m² onto a resulting product, and cured with the mercury lamp to obtain a pretreated substrate.

The digital printing adopted UV ink LUS-210 from Shenzhen Galaxy Union Digital Technology Co., Ltd., China. BMZ-5100, BMZ-3016, BMZ-824WH, BMZ-855, and BMZ-323C were all from Banfert New Materials Co., Ltd., China.
2. A transfer film was connected from the unwinding device, the transfer glaze coating application device, the first UV curing device, the first pressure roller, the second UV curing device, the second pressure roller, and the winding device in sequence, as shown in FIGURE. A running direction of the transfer film, the guide rollers, the transfer glaze coating application device, and the substrate transport device is shown by arrows in FIGURE. A UV glazed paint was applied onto the transfer film and cured with the first UV curing device. A UV intermediate coating paint was applied to the pretreated substrate but not cured, and a running direction of the substrate is indicated by the arrows. The the transfer film applied with a UV glazed coating was laminated onto the pretreated substrate coated with a UV intermediate coating by using the first pressure roller and the second pressure roller. The UV glazed coating was in contact with the UV intermediate coating. Whole coating was cured under the action of the second UV curing device. The UV glazed coating was fixed to a surface of the substrate. The transfer film was then removed from the surface of a resulting coating and collected onto the winding device. The whole coating was strengthened and cured under the action of the third curing device to obtain the product containing the transfer glaze coating.

The transfer film was a PET film with a thickness of 100 μm, had the characteristic of mirror-like flatness, and was available from Anhui Ocan Material Co., Ltd., China. A transferred UV glaze coating exhibits a mirror-like high-gloss effect. The UV glazed coating had a thickness of 8 μm. Raw materials for the UV glazed paint (in parts by mass) consisted of 15 parts of wear-resistant particles, 55 parts of acrylate resin, 3 parts of a photoinitiator, 26 parts of a reactive diluent, and 1 part of an additive. The wear-resistant particles were diamond micro-powder of 10 μm, available from Henan Boron Ultrahard Material Co., Ltd., China. The acrylate resin was 9-functional polyurethane acrylate of TUN 142, available from Banfert New Materials Co., Ltd., China. The photoinitiator consisted of 2 parts of TPO (2,4,6-trimethylbenzoyldiphenyl phosphine oxide) and 1 part of 184 (1-hydroxycyclohexyl phenyl ketone). The reactive diluent was DPGDA (dipropylene glycol diacrylate). The additive consisted of 0.4 parts of a dispersant, 0.2 parts of a defoamer, and 0.4 parts of an anti-settling additive, where the dispersant was BASF EFKA-AFCONA-4010, the defoamer was TEGO Airex 920, and the anti-settling additive was fumed silica of Aerosil R974. The UV intermediate coating paint was available as MEC-04 from Banfert New Materials Co., Ltd., China.

### Example 2

An apparatus for preparing a product containing a transfer glaze coating was the same as that in Example 1.

A method for preparing the product containing the transfer glaze coating by using the apparatus was performed as follows:
1. An SPC substrate (one of PVC substrates) was polished and planarized, then adhesive primer BPVC-1335 was applied thereon at a coating thickness of 10 g/m² and cured with a mercury lamp. 2 coats of covering white base BMZ-824WH were applied at 20 g/m² per coat onto a resulting product, and cured by using a gallium lamp after each coat. Then, digital printing was conducted on a resulting product to obtain a pattern layer. Adhesive primer BMZ-855 was applied at a coating thickness of 10 g/m² onto the pattern layer and cured with the mercury lamp. Wear-resistant primer BMZ-323C was applied at a coating thickness of 80 g/m² onto a resulting product, and cured with the mercury lamp to obtain a pretreated substrate.

BPVC-1335, BMZ-824WH, BMZ-855, and BMZ-323C were all from Banfert New Materials Co., Ltd., China. The digital printing adopted UV ink LUS-210 from Shenzhen Galaxy Union Digital Technology Co., Ltd., China.

Step 2 was the same as that in Example 1.

### Example 3

An apparatus for preparing a product containing a transfer glaze coating was the same as that in Example 1.

A method for preparing the product containing the transfer glaze coating by using the apparatus was performed as follows:
1. Digital printing was conducted on a PVC white film side of an SPC substrate containing a PVC white film to obtain a pattern layer. Adhesive primer BPVC-1335 was applied at a coating thickness of 10 g/m² onto the pattern layer and cured with a mercury lamp. Wear-resistant primer BMZ-323C was applied at a coating thickness of 80 g/m² onto a resulting product and cured with the mercury lamp to obtain a pretreated substrate.

The SPC substrate containing the PVC white film was available from Zhejiang Yongyu Household Co., Ltd., China. BPVC-1335 and BMZ-323C were available from Banfert New Materials Co., Ltd., China. The digital printing adopted UV ink LUS-210 from Shenzhen Galaxy Union Digital Technology Co., Ltd., China.

Step 2 was the same as that in Example 1.

### Example 4

An apparatus for preparing a product containing a transfer glaze coating was the same as that in Example 1.

A method for preparing the product containing the transfer glaze coating by using the apparatus was performed as follows:
1. Adhesive primer BPVC-1335 was applied, at a coating thickness of 10 g/m², onto an SPC substrate containing a PVC printed film and cured with a mercury lamp. Wear-resistant primer BMZ-323C was applied at a coating thickness of 80 g/m² onto a resulting product and cured with the mercury lamp to obtain a pretreated substrate.

The SPC substrate containing the PVC printed film was available from Zhejiang Yongyu Household Co., Ltd., China. BPVC-1335 and BMZ-323C were available from Banfert New Materials Co., Ltd., China.

Step 2 was the same as that in Example 1.

### Example 5

An apparatus for preparing a product containing a transfer glaze coating was the same as that in Example 1.

A method for preparing the product containing the transfer glaze coating by using the apparatus was performed as follows:
1. Adhesive primer BPVC-1335 was applied, at a coating thickness of 10 g/m², onto a transparent film side of a composite substrate containing an SPC substrate, a PVC printed film, and a PVC transparent film that were sequentially stacked, and was cured with a mercury lamp. Wear-resistant primer BMZ-323C was applied at a coating thickness of 80 g/m² onto a resulting product, and cured with the mercury lamp to obtain a pretreated substrate.

The composite substrate containing the SPC substrate, the PVC printed film, and the PVC transparent film that were sequentially stacked was available from Zhejiang Yongyu Household Co., Ltd., China. BPVC-1335 and BMZ-323C were available from Banfert New Materials Co., Ltd., China.

Step 2 was the same as that in Example 1.

### Example 6

An apparatus for preparing a product containing a transfer glaze coating was the same as that in Example 1.

A method for preparing the product containing the transfer glaze coating by using the apparatus was performed as follows:
1. Adhesive primer BPVC-1335 was applied, at a coating thickness of 10 g/m², onto a transparent film side of a composite substrate containing an SPC substrate, a PVC printed film, and a PVC transparent film that were sequentially stacked, and was cured with a mercury lamp to obtain a pretreated substrate.

The composite substrate containing the SPC substrate, the PVC printed film, and the PVC transparent film that were sequentially stacked was available from Zhejiang Yongyu Household Co., Ltd., China. BPVC-1335 was available from Banfert New Materials Co., Ltd., China.

Step 2 was the same as that in Example 1.

### Example 7

An apparatus for preparing a product containing a transfer glaze coating was the same as that in Example 1.

A method for preparing the product containing the transfer glaze coating by using the apparatus was performed as follows:
A PET substrate was polished and planarized, then adhesive primer BPT-2101A was applied thereon at a coating thickness of 10 g/m² and cured with a mercury lamp. 2 coats of covering white base BMZ-824WH were applied at 20 g/m² per coat onto a resulting product, and cured by using a gallium lamp after each coat. Then, digital printing was conducted on a resulting product to obtain a pattern layer. Adhesive primer BMZ-855 was applied at a coating thickness of 10 g/m² onto the pattern layer and cured with the mercury lamp. Wear-resistant primer BMZ-323C was applied at a coating thickness of 80 g/m² onto a resulting product, and cured with the mercury lamp to obtain a pretreated substrate.

BPT-2101A, BMZ-824WH, BMZ-855, and BMZ-323C were all from Banfert New Materials Co., Ltd., China. The digital printing adopted UV ink LUS-210 from Shenzhen Galaxy Union Digital Technology Co., Ltd., China.

Step 2 was the same as that in Example 1.

### Example 8

An apparatus for preparing a product containing a transfer glaze coating differs from that in Example 2 only in that:

A lamp source of the first UV curing device 6 was a UV-LED lamp, a lamp source of the second UV curing device 9 was a UV-LED lamp, and the substrate coating device 11 was a laser roller coater.

A method for preparing the product containing the transfer glaze coating by using the apparatus differs from that in Example 2 only in that:

In step 2, the transfer film was a BOPP matt film with a thickness of 50 μm from Shijiazhuang Dadao Packaging Co., Ltd., China. The transferred UV glazed coating exhibits a matte effect.

### Example 9

An apparatus for preparing a product containing a transfer glaze coating differs from that in Example 2 only in that:

A lamp source of the first UV curing device 6 was a mercury lamp, a lamp source of the second UV curing device 9 was a gallium lamp, and a lamp source of the third curing device 13 was a UV-LED lamp+a mercury lamp.

A method for preparing the product containing the transfer glaze coating by using the apparatus differs from that in Example 2 only in that:

In step 2, the transfer film was a PP sanded-texture film with a thickness of 30 μm from Shenzhen Jinjiang New Materials Technology Co., Ltd., China. The transferred UV glazed coating exhibits a sanded-texture effect.

### Example 10

An apparatus for preparing a product containing a transfer glaze coating differs from that in Example 2 only in that:

There was no third curing device.

A method for preparing the product containing the transfer glaze coating by using the apparatus differs from that in Example 2 only in that:

The whole coating was not strengthened and cured.

### Example 11

An apparatus for preparing a product containing a transfer glaze coating was the same as that in Example 2.

A method for preparing the product containing the transfer glaze coating by using the apparatus differs from that in Example 2 only in that:

In step 2, the UV glazed coating had a thickness of 15 μm. Raw materials for the UV glazed paint (in parts by mass) consisted of 20 parts of wear-resistant particles, 3 parts of nano-particles, 20 parts of acrylate resin, 25 parts of a photocurable resin, 2.5 parts of a photoinitiator, 28 parts of a reactive diluent, and 1.5 parts of an additive. The wear-resistant particles consisted of 5 parts of silicon carbide powder with a particle size of 5 μm and 15 parts of alumina micro-powder with a particle size of 15 μm, both available from Shandong Jinmeng New Materials Co., Ltd., China. The nano-particles were alumina with a particle size of 30 nm from Huzhou Mister New Materials Co., Ltd., China. The acrylate resin was 9-functional polyurethane acrylate of TUN 142. The photocurable resin was 2-functional epoxy acrylic resin of TUE21. The acrylate resin and the photocurable resin were all from Banfert New Materials Co., Ltd., China. The photoinitiator was 184 (1-hydroxycyclohexyl phenyl ketone). The reactive diluent was DPGDA (dipropylene glycol diacrylate). The additive consisted of 0.8 parts of a dispersant, 0.2 parts of a defoamer, and 0.5 parts of an anti-settling additive, where the dispersant was BASF EFKA-AFCONA-4010, the defoamer was TEGO Airex 920, and the anti-settling additive was fumed silica of Aerosil R974.

### Performance Tests

(1) Glossiness: 60° specular glossiness of decorative panels obtained from the examples was tested according to GB/T 9754-2007 standards.
(2) Wear resistance: Wear resistance of decorative panels obtained from the examples was tested according to GB/T 1768-2006 standards under the following conditions: a load of 500 g and P180 sandpaper. A wear value at 100 revolutions was tested. The smaller the wear value is, the better the wear resistance is.
(3) Repetitive traffic scratches: According to an additional test method HSP1305MM of EN 16094-2021, the repetitive traffic scratch resistance of decorative panels obtained from the examples was tested, with rating grades ranging from C1 (best) to C5 (worst).

Test results are shown in Table 1.

TABLE 1
Performance Test Results of Floor Decoration Materials Obtained
From Examples and Ceramic Tiles of a Certain Brand

| | | Wear | Repetitive |
|---|---|---|---|
| | Glossiness and | resistance | traffic |
| Test items | surface effect | (mg) | scratches |
| Example 1 | 94°, mirror-like effect | 2.5 | C2 |
| Example 2 | 95°, mirror-like effect | 2.8 | C2 |
| Example 3 | 95°, mirror-like effect | 2.8 | C2 |
| Example 4 | 95°, mirror-like effect | 2.8 | C2 |
| Example 5 | 95°, mirror-like effect | 3.1 | C2 |
| Example 6 | 96°, mirror-like effect | 4.5 | C2 |
| Example 7 | 96°, mirror-like effect | 2.7 | C2 |
| Example 8 | 5°, matte effect | 4.6 | C3 |
| Example 9 | 36°, sanded-texture effect | 1.9 | C2 |
| Example 10 | 95°, mirror-like effect | 5.6 | C3 |
| Example 11 | 95°, mirror-like effect | 1.7 | C2 |
| Ceramic tiles of | 95°, mirror-like effect | 1.4 | C3 |
| a certain brand | | | |

Repetitive traffic scratches are used to evaluate the scratch resistance of decorative panels under harsh conditions. Specifically, the scratch resistance is evaluated under certain loads of high hardness or sharp materials. It can be seen from Table 1 that the decorative panels in the examples exhibit scratch resistance substantially superior to that of the tiles and wear resistance approximately equal to that of the tiles. Therefore, the product containing the transfer glaze coating prepared by the apparatus and the method according to the present disclosure exhibits excellent wear and scratch resistance while achieving the mirror-like effect, and can also achieve excellent wear and scratch resistance while achieving different glossiness and textured effects.

Although the embodiments described above have provided a detailed description of the present disclosure, they are only a part of, rather than all of the embodiments of the present disclosure. All other embodiments that can be obtained according to the embodiments of the present disclosure without inventive efforts shall fall within the scope of the present disclosure.

1. An apparatus for preparing a product containing a transfer glaze coating, comprising:
an unwinding device for a transfer film and a winding device for the transfer film;
a transfer glaze coating application device, a first UV (ultraviolet) curing device, a first pressure roller, a second UV curing device, and a second pressure roller which are sequentially arranged in a running direction of the transfer film; and
a substrate transport device;
wherein the transfer glaze coating application device comprises a uniform distribution roller, an application roller, and a bottom roller.

2. The apparatus for preparing the product containing the transfer glaze coating of claim 1, wherein each of the first UV curing device and the second UV curing device comprises a lamp source, wherein the lamp source comprises at least one selected from the group consisting of a gallium lamp, a mercury lamp, a UV-LED (ultraviolet-light emitting diode) lamp, a halogen lamp, and an electrodeless lamp.

3. The apparatus for preparing the product containing the transfer glaze coating of claim 1, further comprising: a substrate application device configured to prepare a substrate to be transferred, wherein the substrate application device is one selected from the group consisting of a reversible roller coater and a laser roller coater.

4. The apparatus for preparing the product containing the transfer glaze coating of claim 1, further comprising: a third curing device configured to cure a product from which the transfer film is removed, wherein the third curing device comprises a lamp source, wherein the lamp source comprises at least one selected from the group consisting of a gallium lamp, a mercury lamp, a UV-LED lamp, a halogen lamp, an electrodeless lamp, and an EB (electron beam) curing machine.

5. (canceled)

6. The apparatus for preparing the product containing the transfer glaze coating of claim 1, further comprising: a guide roller configured to control a direction of the transfer film.

7. A method for preparing the product containing the transfer glaze coating by using the apparatus of claim 1, comprising the following steps:
connecting the transfer film from the unwinding device to the winding device through the transfer glaze coating application device, the first UV curing device, the first pressure roller, the second UV curing device, and the second pressure roller in sequence;
applying a UV glazed paint onto a surface of the transfer film by using the transfer glaze coating application device, and subjecting a resulting product to a first curing by using the first UV curing device to obtain a transfer film coated with the transfer glaze coating; and
laminating, through the first pressure roller and the second pressure roller, the transfer film coated with the transfer glaze coating on a surface of a substrate to be transferred, subjecting a resulting system to a second curing by using the second UV curing device during the laminating, collecting the transfer film by using the winding device, and transferring the transfer glaze coating to the surface of the substrate to be transferred to obtain the product containing the transfer glaze coating.

8. The method for preparing the product containing the transfer glaze coating of claim 7, wherein the transfer film comprises one selected from the group consisting of a polyester film, a polypropylene film, and a polyethylene film; and the transfer film has a thickness of 20 μm to 500 μm.

9. The method for preparing the product containing the transfer glaze coating of claim 7, wherein raw materials for preparing the UV glazed paint comprise the following components in parts by mass: 5 parts to 50 parts of wear-resistant particles, 10 parts to 80 parts of a polyfunctional acrylate resin, 0 to 50 parts of a photocurable resin, 1 part to 5 parts of a photoinitiator, 0 to 50 parts of an active diluent, and 0.1 parts to 5 parts of an additive.

10. The method for preparing the product containing the transfer glaze coating of claim 9, wherein the wear-resistant particles are at least one selected from the group consisting of alumina, zirconia, silicon carbide, boron carbide, silicon nitride, boron nitride, and diamond micro-powder; and the wear-resistant particles each have a particle size of 1 μm to 30 μm.

11. The method for preparing the product containing the transfer glaze coating of claim 10, wherein the raw materials for preparing the UV glazed paint further comprise nano-particles, wherein a mass percentage of the nano-particles in the UV glazed paint is in a range of 0.5% to 10%.

12. The method for preparing the product containing the transfer glaze coating of claim 7, wherein the transfer glaze coating has a thickness of 3 μm to 20 μm.

13. The method for preparing the product containing the transfer glaze coating of claim 7, wherein the substrate to be transferred comprises a substrate and an intermediate coating on a surface of the substrate, wherein the intermediate coating is an uncured UV coating.

14. The method for preparing the product containing the transfer glaze coating of claim 7, wherein a curing energy of the first curing is in a range of 50 mJ/cm² to 1,000 mJ/cm²; and a curing energy of the second curing is in a range of 100 mJ/cm² to 2,000 mJ/cm².

15. The method for preparing the product containing the transfer glaze coating of claim 7, wherein the method further comprises: after transferring the transfer glaze coating to the surface of the substrate to be transferred, subjecting a resulting product from which the transfer film is removed to a third curing by using a third curing device.

16. The method for preparing the product containing the transfer glaze coating of claim 15, wherein a curing energy of the third curing is in a range of 300 mJ/cm² to 5,000 mJ/cm².

17. The apparatus for preparing the product containing the transfer glaze coating of claim 3, further comprising: a third curing device configured to cure a product from which the transfer film is removed, wherein the third curing device comprises a lamp source, wherein the lamp source comprises at least one selected from the group consisting of a gallium lamp, a mercury lamp, a UV-LED lamp, a halogen lamp, an electrodeless lamp, and an EB (electron beam) curing machine.

18. The method for preparing the product containing the transfer glaze coating of claim 13, wherein the method further comprises: after transferring the transfer glaze coating to the surface of the substrate to be transferred, subjecting a resulting product from which the transfer film is removed to a third curing by using a third curing device.
